(19) United States
(12) Patent Application Publication
(10) Pub. No.: US 2009/0153852 A1
(43) Pub. Date: Jun. 18, 2009

(54) OPTICAL FIBER FOR SPECTROSCOPIC ANALYSIS SYSTEM

(75) Inventor: Wouter Harry Jacinth Rensen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/568,198

(22) PCT Filed: Apr. 12, 2005
(86) PCT No.: PCT/IB05/51204

§ 371 Date: Oct. 23, 2006

(30) Foreign Application Priority Data
Apr. 27, 2004 (EP) 04101758.3

(51) Int. Cl. G01J 3/00; G02B 6/26; G02B 6/02

(52) U.S. Cl. 356/300; 385/31; 385/123

(57) ABSTRACT

The present invention provides an optical fiber for connecting a probe head and a base station of a spectroscopic analysis system for analyzing the molecular composition of a volume of interest. The optical fiber comprises a core for transmission of excitation radiation from the base station to the probe head and a first cladding for transmission of multi-mode return radiation from the probe head to a spectroscopic analysis unit of the base station. Preferably, the first cladding is surrounded by a second cladding and therefore provides a multi-mode wave guide by itself. Appropriately designing the dimensions of the core, the first cladding and the second cladding provides an optimal collection and coupling efficiency of the optical fiber. Coating of the distal end facet of the optical fiber with multi-layer optical filters allows an effective separation of elastically and inelastically scattered radiation which is of advantage for the spectroscopic analysis.

The present invention relates to the field of spectroscopy.

Usage of optical spectroscopy techniques for analytical purposes is as such known from the prior art. WO 02/057758 A1 and WO 02/057759 A1 show spectroscopic analysis apparatuses for in vivo non-invasive spectroscopic analysis of the composition of blood flowing through a capillary vessel of a patient. The position of the capillary vessel is determined by an imaging system in order to identify a region of interest to which an excitation beam for the spectroscopic analysis has to be directed.

For many applications it is advantageous to divide the spectroscopic system into a base station and a small, compact and flexible probe head. Typically, the base station has a laser light source and a spectrometer that are relatively large in size. Therefore, the probe can be designed by making use of a limited number of components allowing for a compact geometry and robust handling of the probe head. The probe head has an objective for focusing an excitation beam into a volume of interest and for collecting return radiation from the volume of interest.

Due to its size constraints, the probe head cannot provide spectroscopic analysis of the return radiation. Therefore, it is of practical use to connect the probe head to the base station by means of an optical fiber providing bi-directional transmission of optical signals. On the one hand, an excitation beam of e.g. a near infrared laser, has to be transmitted from the base station to the probe head. And on the other hand, the spectrum of the scattered radiation returning from the volume of interest is indicative of the molecular composition of the volume of interest. In order to be spectrally analyzed, it has to be collected by the probe head and to be transmitted from the probe head to the spectrometer of the base station.

The US patent application 2003/0191398 A1 discloses systems and methods for spectroscopy of biological tissue. This system in particular includes a fiber optic probe with a proximal and a distal end. A delivery optical fiber (or fibers) is included in the probe coupled at the proximal end to a light source. The system includes a collection optical fiber (or fibers) in the probe that collects Raman scattered radiation from tissue, the collection optical fiber is coupled at the proximal end to a detector. Here, the probe comprises a first plurality of collection fibers arranged concentrically about the delivery fiber at a first radius, and a second plurality of collection fibers arranged concentrically about the delivery fiber at a second radius that is larger than the first radius.

Hence, the fiber optic probe of US 2003/0191398 A1 makes use of a plurality of collection fibers being arranged concentrically about the delivery fiber at a certain radius, the entire cross section of the fiber optic probe cannot be used for transmission of collected radiation. Since the collection fibers and the excitation fiber feature a circular cross section, any arrangement of a plurality of collection fibers inevitably features interstices or gaps between the collection fibers that are not capable for guiding optical signals.

It is due to these interstices or gaps, that the fiber optic probe of US 2003/0191398 A1 features a limited coupling efficiency or collection efficiency for radiation that has to be transmitted from the probe head to the base station.

The present invention therefore aims to provide an improved optical fiber for transmission of excitation and return radiation between the probe head and the base station of a spectroscopic analysis system.

The present invention provides an optical fiber for connecting a probe head and a base station of a spectroscopic analysis system for analyzing a volume of interest. The optical fiber comprises a core for transmission of excitation radiation to the volume of interest and a first cladding for multi-mode transmission of return radiation from the volume of interest. The core is typically designed as a rod and is located in the center of the first cladding surrounding the core. Preferably, the diameter of the core is much smaller than the diameter of the first cladding. The first cladding itself serves as a multi-mode wave guide for the return radiation that is collected from the volume of interest by means of the objective of the probe head.

Furthermore, the first cladding is surrounded by a second cladding in order to guarantee a wave guiding effect of the first cladding.

According to a further preferred embodiment of the invention, the refractive index of the core is larger than the refractive index of the first cladding. Moreover, the refractive index of the second cladding is smaller than the refractive index of the first cladding. In this way, the core and the first cladding serve as a wave guiding structure for the excitation radiation and the first cladding in combination with the second cladding serve as a multi-mode wave guiding structure for the return radiation.

In contrast to the prior art, the inventive optical fiber is based on a maximum number of three different basic components, namely the first core, the first cladding and the second cladding for providing a bi-directional transmission of excitation and return radiation. Instead of making use of a plurality of collection fibers that have to be arranged according to a distinct pattern as disclosed in the prior art, the invention makes effective use of the first cladding having a large diameter and providing a multi-mode wave guide by itself.

Moreover, the entire cross section of the inventive optical fiber can be used for trans-mission of optical signals. This provides a maximum of coupling and collection efficiency of the optical fiber because interstices or gaps between a plurality of different optical fibers do not appear in this configuration.

Therefore, the inventive optical fiber provides a high light collection efficiency in combination with a compact and a non-complex design of its cross section.

According to a further preferred embodiment of the invention, the core of the optical fiber is adapted to provide a single mode wave guide for the excitation radiation. When for example the excitation radiation is in the range of near infrared radiation (NIR) for performing Raman spectroscopy, the diameter of the core should not exceed a few micrometers. Preferably, the diameter of the core is in the range between 2 and 5 micrometers. Such a small diameter of the core in combination with a rather large diameter of the first cladding exceeding even 100 micrometers results in a high collection and coupling efficiency for the return radiation. Consequently, a major part of the cross section of the inventive optical fiber is adapted for multi-mode transmission of return radiation from the probe head to the base station. This feature is particularly advantageous in order to enhance detection efficiency of the relevant spectroscopic data.

In designing the core as a single mode wave guide for the excitation radiation provides one further advantage. As a result of the propagation in single mode fiber, the beam profile of the excitation beam propagating through the core becomes Gaussian or Gaussian-like shaped. Such a Gaussian beam profile is advantageous in order to achieve a high quality of focus when the excitation beam is focused into the volume of interest by the objective lens of the probe head. Moreover, the laser light source does not necessarily have to provide a perfect Gaussian beam profile. Thus, the specifications of the laser light source or the light source providing the excitation radiation do not require a top level standard regarding the transverse beam profile. Hence, even a low-cost laser light source providing a low quality transverse beam profile could in principle be implemented.

According to a further preferred embodiment of the invention, a proximal end of the core is adapted to be coupled to a source of radiation generating the excitation radiation. For example a high intense laser beam of a near infrared laser is coupled into the core of the inventive optical fiber. Therefore, the proximal end of the fiber is located inside the base station of the spectroscopic analysis system accommodating the laser light source.

According to a further preferred embodiment of the invention, the proximal end of the first cladding is further adapted to be coupled to a spectrometer or a similar detector element.

According to a further preferred embodiment of the invention, the optical fiber has a first filter element at a distal end of the first cladding. Preferably, the first filter is implemented as a multi-layer optical filter of dielectric material providing a high reflectivity for the excitation radiation and a high transmission for frequency- or wavelength shifted portions of the return radiation.

By focusing the excitation beam into a volume of interest a plurality of different scattering effects may arise. A major part of the return radiation is due to Rayleigh scattering or elastic scattering leaving the frequency of the excitation radiation unaltered. Typically, a minor part of the return radiation is due to inelastic scattering of the excitation radiation leading to a frequency shift of the scattered radiation. This frequency shift is indicative of various energy levels of the molecules that are located in the volume of interest. This Raman shifted portion of the return radiation is therefore indicative of the molecular composition of the volume of interest.

Hence, the first filter element is adapted to selectively filter the frequency shifted components of the return radiation. In this way the first filter element serves as a dichroic mirror for separating radiation that is due to elastic and inelastic scattering processes.

According to a further preferred embodiment of the invention, the optical fiber has a second filter element at a distal end of the core. Again, this second filter element is preferably designed as a multi-layer coating to create a narrow band pass filter on the distal facet of the single mode core in order to block fluorescent light created in the fiber by the excitation radiation. Depending on the geometry, in particular, the length of the fiber, the materials used, the numerical aperture of the single mode core and the intensity of the incident excitation beam, propagation of the excitation beam inside the core of the optical fiber already produces non-negligible background fluorescence and Raman signals that may remarkably spoil the measurement results. By making use of this second filter element having a high transmission only for the excitation radiation, unwanted background signals that are produced during propagation of the excitation beam in the core of the fiber can be effectively prevented from entering the volume of interest.

According to a further preferred embodiment of the invention, the first filter element is at a distal end of the core and at the distal end of the first cladding. In other words, the first filter element having a high reflectivity or absorption for the excitation radiation and a high transmission for the frequency shifted return radiation covers the entire cross section of the distal end of the inventive optical fiber. Even though the first filter element effectively blocks the excitation radiation from emitting, this embodiment is advantageous for the production process of the fiber and in particular for coating the distal facet of the fiber with an appropriate multi-layer coating.

In particular, when the first filter element features a high absorption coefficient for the excitation radiation, by coupling a high power laser to the single mode core to the proximal end of the fiber will locally destroy the first filter element in the vicinity of the core due to a high amount of energy deposition. The remains of the first filter element then serve as a notch filter only covering the cladding of the optical fiber.

According to a further preferred embodiment of the invention, the proximal end of the core protrudes beyond the proximal end of the first cladding. Since the core is adapted to provide excitation radiation to the probe head and the first cladding is adapted to provide return radiation to the base station and hence to the proximal end of the first cladding, the coupling of radiation into the fiber and the detection of radiation emitting from the fiber has to be separated by some means. Protruding of the proximal end of the core with respect to the proximal end of the first cladding allows a separate access to the core and the first cladding of the inventive optical fiber.

According to a further preferred embodiment of the invention, the proximal end of the core is further coupled to a deflection element for coupling of excitation radiation into the core. When the protruding core is for example coupled to a micro-prism allowing for a deflection of radiation of e.g. 90 degrees, a laser light source generating the required excitation radiation can be spatially separated from the spectroscopic analysis unit inside the base station of the spectroscopic system. Making use of a 90 degree deflection prism for example allows to implement an optical arrangement where the input angle for the laser light becomes substantially perpendicular to the propagation direction of the collected return radiation that is guided by means of the first cladding.

According to a further preferred embodiment of the invention, the proximal end of the core protruding the proximal end of the first cladding is adapted to be bent by a certain angle with respect to the longitudinal direction of the first cladding. In this way, the different optical signals that are transmitted by the optical fiber can be effectively separated within the base station of the spectroscopic system.

According to a further preferred embodiment of the invention, the refractive index of the core and the refractive index of the first cladding are constant with respect to the radial distance from the center of the core. Hence the core and the first cladding feature a constant refractive index. The wave guiding structure formed by the core and the first cladding therefore represents a stepped index wave guide.

According to a further preferred embodiment of the invention, the refractive index of the core and the refractive index of the first cladding form a graded refractive index profile being non-uniform with respect to the radial distance from the center of the core. Consequently, the wave guiding structure formed by the core and the first cladding is implemented as a graded index wave guide and the entire optical fiber is implemented as a graded index fiber.

According to another aspect, the invention provides a spectroscopic system for performing a spectroscopic analysis of a volume of interest. The spectroscopic system has a base station and a probe head that are connected by means of an optical fiber. The optical fiber comprises a core for transmission of excitation radiation to the volume of interest, i.e. transmission of excitation radiation from the base station to the probe head. The optical fiber further comprising a first cladding for transmission of multi-mode return radiation from the volume of interest, i.e. transmission of collected return radiation from the probe head to the base station.

In another aspect, the invention provides a probe head of a spectroscopic system for performing a spectroscopic analysis of a volume of interest. The probe head is adapted to be connected to a base station of the spectroscopic system by means of an optical fiber. The optical fiber comprises a core for transmission of excitation radiation to the volume of interest and a first cladding for multi-mode transmission of return radiation from the volume of interest.

In still another aspect, the invention provides a base station of a spectroscopic system for performing a spectroscopic analysis of a volume of interest. The base station is adapted to be connected to a probe head of the spectroscopic system by means of an optical fiber. The optical fiber comprises a core for transmission of excitation radiation to the volume of interest and a first cladding for multi-mode transmission of return radiation from the volume of interest.

It is to be noted, that the present invention is not restricted to a particular type of spectroscopic techniques, as e.g. Raman spectroscopy, but that other optical spectroscopic techniques can also be used. This includes (i) other methods based on Raman scattering including stimulated Raman spectroscopy and coherent anti-Stokes Raman spectroscopy (CARS), (ii) infra-red spectroscopy, in particular infra-red absorption spectroscopy, Fourier transform infra-red (FTIR) spectroscopy and near infra-red (NIR) diffusive reflection spectroscopy, (iii) other scattering spectroscopy techniques, in particular fluorescence spectroscopy, multi-photon fluorescence spectroscopy and reflectance spectroscopy, and (iv) other spectroscopic techniques such as photo-acoustic spectroscopy, polarimetry and pump-probe spectroscopy. Preferred spectroscopic techniques for application to the present invention are Raman spectroscopy and fluorescence spectroscopy.

In the following, preferred embodiments of the invention will be described in greater detail by making reference to the drawings in which:

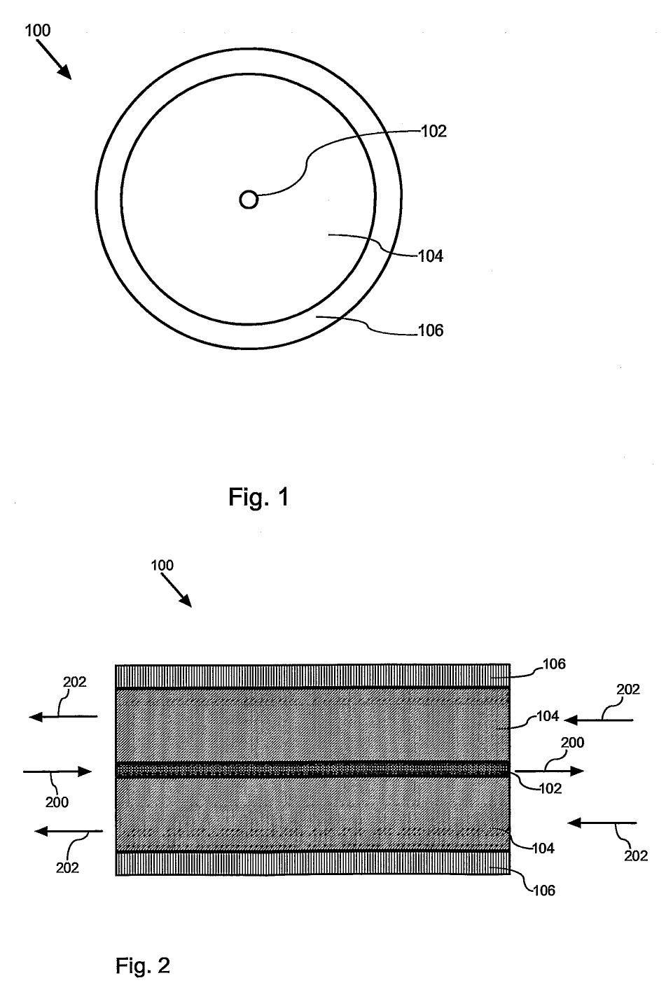

FIG. 1 shows a cross sectional illustration of the inventive optical fiber,

FIG. 2 illustrates a longitudinal section of the inventive optical fiber,

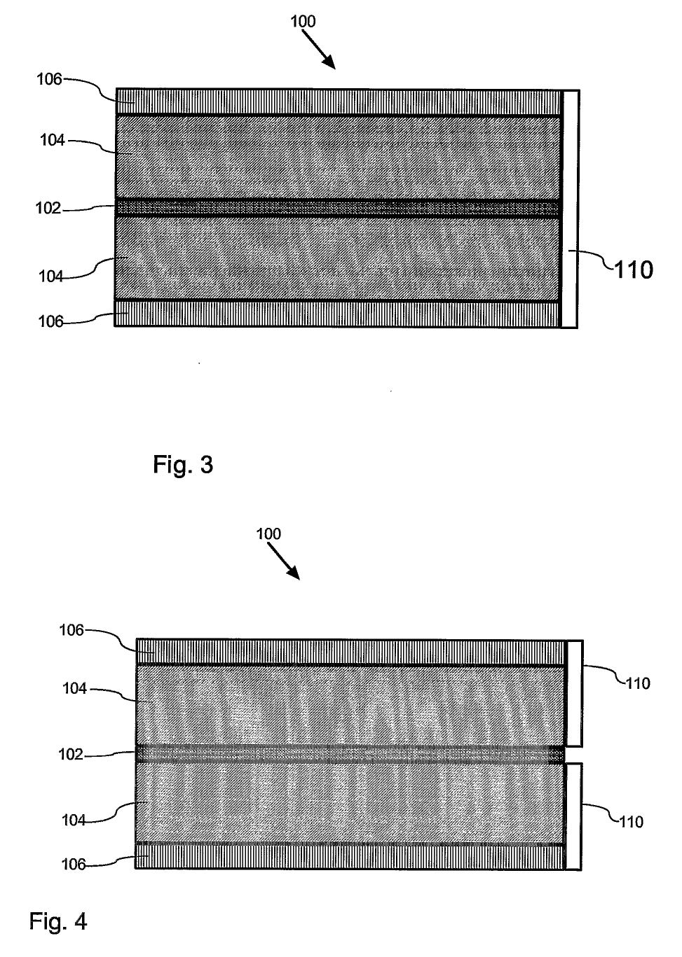

FIG. 3 illustrates a longitudinal section of the optical fiber with a filter element,

FIG. 4 illustrates a longitudinal section of the fiber with a notch filter element,

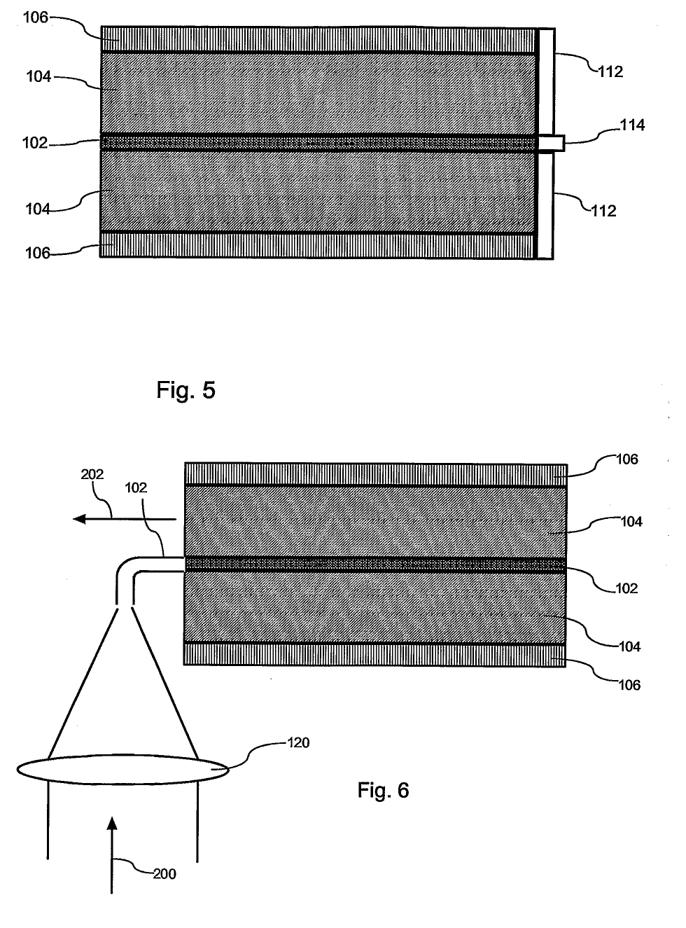

FIG. 5 shows a longitudinal section of the fiber having two different filter elements,

FIG. 6 illustrates a longitudinal section of the fiber with a protruded core,

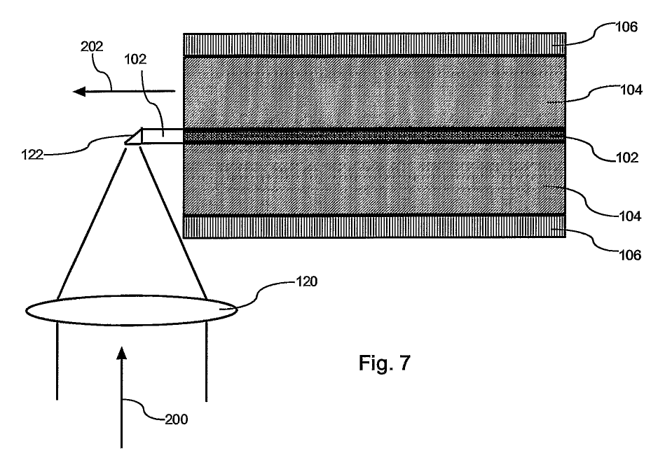

FIG. 7 shows a longitudinal section of the fiber with a deflection element coupled to the core,

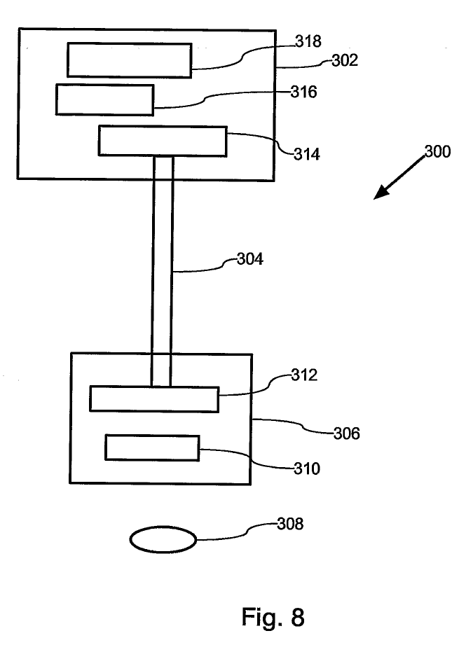

FIG. 8 shows a block diagram of the spectroscopic system.

FIG. 1 shows a cross sectional illustration of the inventive optical fiber 100. The optical fiber 100 has a core 102, a first cladding 104 and a second cladding 106. The core 102 is particularly designed as a single mode wave guide for the excitation radiation that is transmitted from the base station of the spectroscopic system to the probe head of the spectroscopic system. Therefore, the diameter of the core 102 has to be sufficiently small. Making use of near infrared radiation, the core is about 2 to 5 micrometers in diameter. In order to provide effective wave guiding, the core 102 is surrounded by the first cladding 104 featuring a lower refractive index than the refractive index of the core.

The first cladding 104 serves as a multi-mode wave guiding structure itself. Wave guiding of the first cladding 104 can effectively be realized by the second cladding 106 surrounding the first cladding 104. The first cladding 104 therefore features a larger refractive index than the second cladding 106. In this way, the optical fiber 100 provides a single mode wave guide for the excitation radiation and a multi-mode wave guide for collected return radiation and being thus ideally suited to serve as a flexible optical transmission means between a base station and probe head of a spectroscopic analysis system.

Excitation radiation has to be transmitted from the base station to the probe head and the collected return radiation has to be transmitted from the probe head to the base station. Excitation radiation and return radiation are therefore transmitted by the optical fiber in a counter-propagating way. Moreover, since the core and the first cladding remain fixed with respect to each other, the fiber inherently provides a sufficient overlap between an excitation volume and a detection volume within the volume of interest. The location of the excitation volume is governed by the core of the fiber while the detection volume is governed by the first cladding of the fiber. Since cladding and core remain fixed with respect to each other, it is effectively guaranteed that also detection volume and excitation volume substantially overlap. Therefore, there is no need to manually adjust neither the location of the excitation volume nor the location of the detection volume.

The first cladding 104 has a diameter being substantially larger than the diameter of the core 102. Typically, the diameter of the first cladding 104 is around or may even exceed 100 micrometers. In this way the cross sectional surface area of the single mode core 102 is only a small fraction of the cross sectional area of the first cladding 104. Consequently, the collection efficiency or the coupling efficiency of coupling return radiation into the first cladding 104 is much larger than various known prior art solutions where the return radiation is transmitted by a plurality of different optical fibers that are concentrically arranged about an excitation fiber. Compared to these separate collection fibers as known in the prior art, the inventive multi-mode first cladding 104 serving as a collection fiber, provides a higher collection efficiency for the return radiation.

By designing the core 102 of the optical fiber 100 as a single mode wave guide for the excitation radiation, the transverse profile of the excitation beam becomes Gaussian or Gaussian-like shaped. Such a Gaussian excitation beam emerging from the distal end of the optical fiber provides a high quality of focus when the emerging laser beam is subject to focusing by an objective lens of the probe head. In this way, it can be effectively guaranteed that the focal spot size of the excitation beam is within a required range.

FIG. 2 shows a longitudinal section of the optical fiber 100. The core 102 is located in the center of the optical fiber 100 and is further surrounded by the first cladding 104 on either side. The first cladding 104 in turn is surrounded by the second cladding 106. Excitation radiation 200 enters the core from the left and emits from the core to the right. Return radiation 202 is transmitted in a counter-propagating way through the optical fiber 100. Return radiation 202 enters the first cladding 104 from the right and emerges from the first cladding 104 to the left.

The left end of the optical fiber 100 is adapted to be connected to the base station of the spectroscopic system having a laser light source for generating the excitation radiation 200 and having further a spectrometer for spectrally analyzing the return radiation 202. The left end of the optical fiber 100 is further denoted as proximal end. The distal end of the optical fiber 100 specifies the right end of the optical fiber 100. The distal end is adapted to be connected to the probe head of the spectroscopic system. The probe head is further adapted to focus the excitation radiation 200 into a volume of interest by making use of an objective lens. By means of the same objective lens, the measurement head is further adapted to collect return radiation emanating from the volume of interest.

The focused excitation radiation 200 induces numerous scattering processes in the volume of interest, namely elastic scattering processes, like Rayleigh scattering and inelastic scattering processes like Stokes or Anti-Stokes processes resulting in a frequency shift of the scattered radiation. The spectrum of the inelastically scattered light reveals information on the vibrational energy levels of the molecules in the detection volume. This information can be effectively used to identify and quantify various substances (analytes) in for example tissue or blood of a patient.

FIG. 3 illustrates a longitudinal section of the optical fiber having a first filter 110 at its distal end. The filter 110 features a high absorption for the excitation radiation but has a high transmission for Raman shifted return radiation. The filter 110 can be implemented as a multi-layer coating on the entire end facet of the optical fiber 100 covering the cross section of the core 102, the first cladding 104 and the second cladding 106. This filter is adapted for filtering of frequency shifted spectroscopic signals and preventing elastically scattered radiation entering the cladding 104. Elastically scattered radiation having the same wavelength as the excitation radiation is effectively absorbed by the filter 110.

When high intensive laser light is coupled into the proximal end of the core 102 the radiation will be absorbed by the filter 110 leading to a local energy deposition in the filter such that the filter 110 is locally destroyed giving way for emission of the excitation radiation. In this way a notch filter 112 as illustrated in FIG. 4 can be effectively created. The notch filter 112 is basically the remainder of the filter 110 after local removal of the region covering the core 102 of the optical fiber 100. The notch filter 112 has a doughnut like cross sectional shape and covers at least the entire cross section of the first cladding 104 and eventually even the entire cross section of the second cladding 106. The notch filter 112 features a high transmission for Raman shifted return radiation but a high reflectivity or high absorption for elastically scattered radiation, i.e. radiation having the same frequency as the excitation beam.

FIG. 5 is illustrative of a longitudinal section of the optical fiber 100. Compared to FIG. 4, the embodiment of FIG. 5 has an additional filter 114 covering the cross section of the core 102. Preferably, the filter 114 serves as a narrow band pass filter for the excitation radiation. It effectively blocks fluorescent light that is created by scattering processes of the excitation radiation propagating through the core 102 of the fiber 100. Since the return radiation is spectrally analyzed by a spectrometer it is important that the excitation beam is highly monochromatic which can be effectively achieved by the filter 114.

FIG. 6 illustrates a longitudinal section of the fiber 100 wherein the proximal end of the core 102 protrudes beyond the proximal end of the first cladding 104 and the proximal end of the second cladding 106. Furthermore, at its proximal end the core 102 is bent sidewards by about 90 degrees allowing to spatially separate the counter-propagating excitation and return radiation 200, 202. Excitation radiation 200 can effectively be focused into the proximal bend end of the core 102 by means of the focusing lens 120. The excitation beam 200 can therefore propagate substantially perpendicular to the return radiation 202 emerging from the cladding 104 of the fiber 100. When for example the first and the second cladding 104, 106 have an appropriate notch for bending off the core outside of the tube formed by the first and by the second cladding, it is even possible to prolong the proximal end of the core 102 or the cladding 104, 106 arbitrarily. Consequently, the two claddings 104, 106 can be coupled to a spectrometer and the core 102 can be coupled to a laser light sourceaccording to any arbitrary flexible configuration.

FIG. 7 is illustrative of an embodiment wherein the core 102 protrudes beyond the first and the second cladding 104, 106 of the fiber 100 but is not bent sidewards. Here, the proximal end of the core 102 is coupled to a deflection element 102 that redirects the excitation beam 200 for coupling of the excitation beam 200 into the core of the fiber 102. The deflection element 122 can be designed as a micro-prism that is attached to the single mode core 102 by e.g. optical glue. Similar as illustrated in FIG. 6, also here the excitation beam 200 is coupled into the core 102 of the optical fiber 100 in a perpendicular way. Preferably, even the proximal end of the core can be beveled in such a way, that the core itself serves as a deflection element. Consequently, a separate deflection element is generally not required and the rather elaborate task of fixing a deflection element to the proximal end of the core can be left out.

FIG. 8 illustrates a block diagram of a spectroscopic system 300. The spectroscopic system 300 is basically divided into a base station 302, an optical fiber 304 and a probe head 306. The base station has a spectrometer 318, a laser light source 316 as well as coupling means 314. The probe head 306 has coupling means 312 and an objective 310. An excitation beam generated by the laser 316 in the base station 302 is coupled into the optical fiber 304 by making use of the coupling means 314. The optical fiber 304 provides the same features as the optical fiber 100 illustrated in the above described figures. The excitation beam is consequently coupled into the core of the optical fiber 304. The high intensity excitation beam is transmitted to the probe head 304 and focused by means of the objective 310 into the volume of interest 308. The coupling means 312 provide the filters 110, 112, 114.

Return radiation that is due to inelastic scattering processes of the excitation radiation within the volume of interest 308 is collected by the objective 310 and coupled into the first cladding of the optical fiber 304 by making use of the coupling means 312. The return radiation is then transmitted by means of the optical fiber 304 to the coupling means 314 of the base station 302. The coupling means 314 are further adapted to spatially separate the core of the fiber 304 and the cladding of the fiber 304. The cladding serving as a multi-mode wave guide for the return radiation is preferably coupled to the spectrometer 318 of the base station 302 for spectroscopic analysis of the frequency shifted radiation that is due to inelastic scattering processes occurring in the volume of interest 308.

### LIST OF REFERENCE NUMERALS

100 optical fiber
102 core
104 first cladding
106 second cladding
110 filter
112 filter
114 filter
120 coupling lens
122 deflection element
200 excitation radiation
202 return radiation
300 spectroscopic system
302 base station
304 optical fiber
306 probe head
308 volume of interest
310 objective
312 coupling means
314 coupling means
316 laser
318 spectrometer

1. An optical fiber (100; 304) for connecting a probe head (306) and a base station (302) of a spectroscopic analysis system (300) for analyzing a volume of interest (308), comprising:
a core (102) for transmission of excitation radiation to the volume of interest,
a first cladding (104) for multi-mode transmission of return radiation (202) from the volume of interest.

2. The optical fiber (100; 304) according to claim 1, wherein the refractive index of the core (102) being larger than the refractive index of the first cladding (104).

3. The optical fiber (100; 304) according to claim 1, wherein the core (102) being adapted to provide a single mode waveguide for the excitation radiation (200).

4. The optical fiber (100; 304) according to claim 1, wherein a proximal end of the core (102) being adapted to be coupled to a source of radiation generating the excitation radiation (200).

5. The optical fiber (100; 304) according to claim 1, wherein the proximal end of the first cladding (104) being adapted to be coupled to a detector element.

6. The optical fiber (100; 304) according to claim 1, having a first filter (110; 112) element at a distal end of the first cladding (104).

7. The optical fiber (100; 304) according to claim 1, having a second filter element (114) at a distal end of the core (102).

8. The optical fiber (100; 304) according to claim 1, having the first filter element (110) at a distal end of the core (102) and at the distal end of the first cladding (104).

9. The optical fiber (100; 304) according to claim 1, wherein the proximal end of the core (102) protrudes beyond the proximal end of the first cladding (104).

10. The optical fiber (100; 304) according to claim 1, wherein the proximal end of the core (102) is coupled to a deflection element (122) for coupling of excitation radiation (200) into the core.

11. The optical fiber (100; 304) according to claim 1, wherein the refractive index of the core (102), and the refractive index of the first cladding (104) being constant with respect to the radial distance from the center of the core.

12. The optical fiber (100; 304) according to claim 1, wherein the refractive index of the core (102) and refractive index of the first cladding (104) form a graded refractive index profile being non-uniform with respect to the radial distance from the center of the core.

13. A spectroscopic system (300) for performing a spectroscopic analysis of a volume of interest (308) having a base station (302) and a probe head (306), the probe head and the base station being connected by means of an optical fiber (100; 304), the optical fiber comprising:
a core (102) for transmission of excitation radiation (200) to the volume of interest (308),
a first cladding (104) for multi-mode transmission of return radiation (202) from the volume of interest.

14. A probe head (306) of a spectroscopic system (300) for performing a spectroscopic analysis of a volume of interest (308), the probe head being adapted to be connected to a base station (302) by means of an optical fiber (100; 304), the optical fiber comprising:
a core (102) for transmission of excitation radiation (200) to the volume of interest,
a first cladding (104) for multi-mode transmission of return radiation (202) from the volume of interest.

15. A base station (302) of a spectroscopic system (300) for performing a spectroscopic analysis of a volume of interest (308), the base station being adapted to be connected to a probe head (306) by means of an optical fiber (100; 304), the optical fiber comprising:
a core (102) for transmission of excitation radiation (200) to the volume of interest,
a first cladding (104) for multi-mode transmission of return radiation (202) from the volume of interest.
